(19) United States
(12) Patent Application Publication
(10) Pub. No.: US 2026/0139659 A1
(43) Pub. Date: May 21, 2026

(54) GEARBOX ARRANGEMENT AND WIND TURBINE

(71) Applicants: ZF Friedrichshafen AG, Friedrichshafen (DE); ZF Wind Power Antwerpen N.V., Lommel (BE)

(72) Inventors: Wim DE LAET, Antwerpen (BE); Bert BEIRINCKX, Ekeren (BE)

(21) Appl. No.: 19/357,176

(22) Filed: Oct. 14, 2025

(30) Foreign Application Priority Data
Oct. 15, 2024 (DE) 102024209977.5

(51) Int. Cl. F03D 13/10; F03D 15/10

(52) U.S. Cl. CPC F03D 13/122; F03D 15/101; F05B 2260/40311

(57) ABSTRACT

A gearbox arrangement for a wind turbine includes a gearbox. A shaft of the gearbox is permanently connected to a further shaft of the wind turbine for conjoint rotation by an interlocking connection when the wind turbine is in an assembled state. The gearbox arrangement has a tensioning device which is designed to remove a clearance at least in a sub-region of the interlocking connection.

### CROSS REFERENCE TO RELATED APPLICATIONS

This application claims benefit to German Patent Application No. DE 10 2024 209 977.5, filed on Oct. 15, 2024, which is hereby incorporated by reference herein.

### FIELD

The present disclosure relates to a gearbox arrangement for a wind turbine. The disclosure also relates to a wind turbine.

### BACKGROUND

Wind turbines are used to generate electricity from wind energy. For this purpose, wind turbines have a rotor. A rotational velocity of the rotor is transmitted to a gearbox by a rotor shaft. The gearbox translates the rotational velocity of the rotor shaft into a suitable rotational speed in order to drive a generator. Owing to their size, modern wind turbines are usually transported to the installation site in multiple parts and are only assembled together on site. A rotor shaft arrangement and the gearbox are, for example, subassemblies that are separate prior to final assembly. Thus, an input shaft of the gearbox and the rotor shaft are often not interconnected until the wind turbine is built. A connection of this kind may have a clearance fit, as a result of which the assembly can be simple. During operation, however, the rotor shaft and the input shaft of the gearbox may move relative to one another at least slightly, potentially leading to positional errors and increased wear. A press fit can prevent this but is difficult to install.

### SUMMARY

In an embodiment, the present disclosure provides gearbox arrangement for a wind turbine. The gearbox arrangement includes a gearbox. A shaft of the gearbox is permanently connected to a further shaft of the wind turbine for conjoint rotation by an interlocking connection when the wind turbine is in an assembled state. The gearbox arrangement has a tensioning device which is configured to remove a clearance at least in a sub-region of the interlocking connection.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a wind turbine comprising a gearbox arrangement, according to one or embodiments of the present disclosure;

FIG. 2 is a schematic sectional side view of a connection of a shaft of the gearbox to a further shaft of the wind turbine in the gearbox arrangement, the connection of an input shaft of the gearbox to a rotor shaft of the wind turbine being shown by way of example, according to one or embodiments of the present disclosure;

FIG. 3 is a schematic perspective view of a tensioning device for said connection illustrated in FIG. 2, according to one or embodiments of the present disclosure;

FIG. 4 is a schematic sectional side view of details of the tensioning device, according to one or embodiments of the present disclosure; and

FIG. 5 is a schematic sectional side view of details of the connection already illustrated in FIG. 2, according to one or embodiments of the present disclosure.

### DETAILED DESCRIPTION

A first aspect relates to a gearbox arrangement for a wind turbine. By way of example, the wind turbine may have a rotor and a generator. The rotor can drive the generator by means of the gearbox in order to generate electrical energy. By way of example, the rotor is connected to the gearbox by means of a rotor shaft. The rotor, gearbox, and generator may, for example, be fastened to a nacelle of the wind turbine. By way of example, the nacelle may be mounted on a tower either non-rotatably or rotatably. The rotor may have a horizontal or vertical axis of rotation. The rotor may, for example, have two, three, four, or more rotor blades, which are connected to the rotor shaft by means of a hub.

The gearbox arrangement has a gearbox. The gearbox may have a gearbox housing. The gearbox housing may, for example, have one or more housing elements. The gearbox housing may form an inner chamber. The gearbox housing may be fastened in the nacelle of the wind turbine. The gearbox may have a drive and an output. By way of example, the drive is mechanically operatively connected to the rotor, and the output is mechanically operatively connected to the generator. The gearbox may have an input shaft. The input shaft may form the drive of the gearbox. The gearbox may be configured to transmit a torque from the rotor shaft of the wind turbine to a generator. The gearbox may have an output shaft. The output shaft may form the output of the gearbox. The gearbox has a shaft, which may, for example, be formed by the input shaft or output shaft. The gearbox arrangement has a further shaft, which is permanently connected to the aforementioned shaft for conjoint rotation. By way of example, the further shaft may be formed by the rotor shaft, an input shaft of the brake, or a further shaft of the generator.

The shaft of the gearbox is permanently connected to the further shaft of the wind turbine for conjoint rotation by an interlocking connection when the wind turbine is in an assembled state. The interlocking connection may, for example, be formed by corresponding surfaces of the two shafts, which surfaces abut one another in the circumferential direction when torque is being transmitted. In this way, during normal use, any rotational movement of one shaft can result in a corresponding rotational movement of the other shaft. The two shafts are arranged coaxially, for example. The interlocking connection may, for example, be configured to transmit torque between the two shafts. The two shafts may additionally be secured together. There may also be axial fixation. The interlocking connection is produced, for example, by inserting or pressing the shafts into one another. In addition, the two shafts may also be screwed together, for example.

By way of example, the gearbox has a planetary gearset or a spur gearset arranged in an inner chamber of the gearbox housing. Planetary gearsets are, for example, formed as a negative planetary gearset or a positive planetary gearset. By way of example, planetary gearsets have a sun gear, a planet carrier, and a ring gear. The sun gears, planet carriers, and ring gears of planetary gearsets form the rotary elements thereof, for example. Each planetary gearset may have one or more planet gears which are rotatably fastened to the planet carrier. The planet gears may be borne on the planet carrier by means of planet pins. The planet pins may be formed separately from or integrally with a carrier element. The planet gears may be rotatably borne on the planet pins. Alternatively or additionally, the planet pins may be rotatably borne on the carrier element. By way of example, the planet gears of a planetary gearset each mesh with a sun gear and a ring gear of a planetary gearset. An axis of rotation of a planetary gearset may correspond to an axis of rotation of the rotary elements. Relevant planetary gearsets may, for example, be arranged coaxially with the rotor shaft.

A rotor-side planet carrier of the planetary gearset may, for example, form a drive of the gearbox. The planet carrier may form one of the two shafts. The planet carrier may form the input shaft of the gearbox. The planet carrier may be formed in one part or multiple parts. The rotor shaft may be formed in one part or multiple parts. For example, the planet carrier has an axial shaft piece at its end that faces the rotor in the assembled state. By way of example, in the assembled wind turbine, the planet carrier may be permanently connected therein to the rotor shaft for conjoint rotation. For example, the two shafts may have mutually corresponding toothings, by means of which the two shafts are mated with one another. The rotor shaft and the planet carrier may be arranged coaxially. The ring gear or sun gear may, for example, form the output of the gearbox. The gearbox may also have a plurality of planetary gearsets that are mechanically operatively interconnected. For example, the output may also be formed by a rotary element of a second planetary gearset. Planetary gearsets can provide high transmission ratios and easily withstand high torques in a space-efficient manner.

The gearbox arrangement has a tensioning device. The tensioning device is configured to remove a clearance at least in a sub-region of the interlocking connection. By way of example, the clearance between the two shafts in the corresponding sub-region may be removed only once the two shafts have been arranged on one another. This can simplify assembly, and yet a long service life of the gearbox can still be achieved. By way of example, the removal of the clearance may be a full or partial elimination of the clearance. By way of example, the clearance may just be reduced, or also the tensioning device may produce a press fit. The clearance may be removed either only in the sub-region of the interlocking connection or everywhere in the interlocking connection. Removing the clearance may bring some surfaces of the two shafts into abutment, for example even when the wind turbine is not currently in operation and, alternatively or additionally, no torque is currently being transmitted.

Removing the clearance may result in some surfaces of the two shafts being pressed against one another. The clearance is removed, for example, by elastic and, alternatively or additionally, plastic deformation of one of the two shafts radially abutting the tensioning device. By way of example, the tensioning device may be arranged so as to abut the shaft of the gearbox radially internally and may press this shaft radially outward against the further shaft. By way of example, the tensioning device may be arranged so as to abut the rotor shaft radially internally and may press the rotor shaft radially outward against the input shaft of the gearbox. By way of example, the tensioning device may be arranged so as to abut the input shaft of the gearbox radially externally and may press the input shaft of the gearbox radially inward against the rotor shaft. By way of example, the tensioning device may be arranged so as to abut the rotor shaft radially externally and may press the rotor shaft radially inward against the input shaft of the gearbox. Accordingly, a connection region of one shaft may be arranged radially internally or externally in relation to a corresponding connection region of the other shaft.

By way of example, the tensioning device may be adjustable between an initial state and a tensioning state. In the initial state, the tensioning device does not deform either of the two shafts, for example. The tensioning device can thus be assembled in a simple manner, for example by being inserted into one of the two shafts or being slipped onto one of the two shafts. In the tensioning state, the tensioning device presses against a portion of one of the shafts, for example, thus removing the clearance in the sub-region of the interlocking connection either at least in part or fully. In the tensioning state, the tensioning device may be held, or even additionally secured, clampingly in the gearbox arrangement, for example by a screw connection. The tensioning device may be adjustable continuously or in steps. In this way, a force by which the tensioning device presses against the abutting shaft out of the two shafts and thus removes the clearance in the interlocking connection can be adjustable, for example. By way of example, the tensioning device may be configured to be adjustable mechanically or hydraulically. Hydraulic adjustability may be particularly quick and can apply high forces in a simple manner. Hydraulic adjustability is thus particularly suitable for validation experiments. Mechanical adjustability may be very cost-effective. Mechanical adjustability is thus particularly suitable for products produced in volume. By way of example, the adjustment into the tensioning state is carried out once the two shafts have been positioned on one another. Before that, radial centering can be carried out, and a relative axial position can also be predetermined. By way of example, the interlocking connection is produced first and at that point can already transmit a torque. Only after that does the adjustment into the tensioning state take place, in order to remove the clearance.

In one embodiment of the gearbox arrangement, it may be provided that the interlocking connection is formed by corresponding toothings of the two shafts. For example, the input shaft may have a toothing formed radially on an external circumference. For example, the rotor shaft may have a toothing formed radially on an internal circumference. The torque is transmitted, for example, by means of respective abutting tooth flanks. By way of example, the toothings may be formed as spline joints. The toothing can allow the two shafts to be assembled together in a simple manner and also allow high torques to be transmitted. In addition, the toothing can provide partial support against tipping. The toothings can also be formed as front toothings that face one another.

In one embodiment of the gearbox arrangement, it may be provided that the tensioning device is configured to remove the clearance at least in the region of tooth flanks, which are adjacent to one another in the circumferential direction, of the corresponding toothings. For example, a diameter of the shaft of the gearbox is expanded by the tensioning device and thus presses the tooth flanks in abutment against the tooth flanks of the further shaft of the wind turbine. Respective addendum regions and dedendum regions of the teeth may also have a clearance from one another. This may allow for slight tipping, potentially preventing undesirable distortion in some bearing concepts for the relevant shafts of the gearbox. However, the tipping can also be suppressed by removing the clearance. A clearance between respective addendum regions and dedendum regions of the teeth can also be removed, as a result of which the connection between the two shafts can be particularly rigid. In this way, for example, when the input shaft is borne solely on the rotor shaft, a position of the input shaft can be particularly readily predetermined. In addition, any warping of the rotor shaft and lateral forces induced by the rotor shaft can be absorbed particularly effectively in this way.

In one embodiment of the gearbox arrangement, it may be provided that the tensioning device is configured to press against that shaft out of the two shafts which is arranged radially adjacent to the tensioning device. The pressing may take place radially outward or inward. For example, one of the two shafts may be radially in contact with the tensioning device, in which case that shaft is the radially adjacent shaft out of said two shafts. The other of the two shafts may be arranged at a radial distance. For example, an external diameter of the tensioning device may abut an internal diameter of the input shaft, which is then radially adjacent to the tensioning device. The input shaft may be arranged radially outside the rotor shaft, and thus at a radial distance from the tensioning device, at least in the region of the interlocking connection of the two shafts.

In one embodiment of the gearbox arrangement, it may be provided that the tensioning device has an expansion sleeve. The expansion sleeve may be configured to expand. The expansion sleeve may have a variable external diameter and, alternatively or additionally, a variable internal diameter. The expansion sleeve may, for example, be adjustable hydraulically or mechanically. For example, the expansion sleeve may have axially displaceable tapered rings, the position of which can change a thickness of the expansion sleeve and thus also the external diameter thereof and, alternatively or additionally, the internal diameter thereof. An expansion sleeve may be cost-effective and, for example, withstand high loads. In addition, an expansion sleeve can bring about strong deformation of one of the two shafts without much force having to be applied. The expansion sleeve may be arranged axially in the region of the interlocking connection.

In one embodiment of the gearbox arrangement, it may be provided that the expansion sleeve is arranged radially internally in relation to the two shafts. In this way, the expansion sleeve can deform the input shaft and, alternatively or additionally, the rotor shaft in a simple manner in order to remove the clearance. For example, the expansion sleeve may abut the input shaft radially internally. The rotor shaft may be arranged radially externally in relation to the input shaft in the region of the interlocking connection. The expansion sleeve may be arranged radially externally or internally in relation to the shaft of the gearbox and, alternatively or additionally, the further shaft of the wind turbine.

In one embodiment of the gearbox arrangement, it may be provided that the interlocking connection is formed as a clearance fit at least in the sub-region in which, for example, the clearance can be removed by the tensioning device. In a clearance fit, there may, for example, always be a clearance between the relevant mating surfaces of the interlocking connection of the two shafts, despite tolerances. Assembly can thus be very simple. For example, a clearance fit can be provided on respective tooth flanks in the circumferential direction. Overall, the interlocking connection can be formed as a clearance fit. Alternatively, it may be provided that the interlocking connection is formed as a transition fit or a press fit at least in the sub-region in which, for example, the clearance can be removed by the tensioning device. In that case, the pressing by the tensioning device can be strengthened. Thus, removing the clearance can also increase the pressing magnitude. In that case, assembly may still be simpler than in the case of assembly directly using a press fit or transition fit desired for operation. There may always be a press fit once the tensioning device has been adjusted into the tensioning state, for example. However, this press fit can also be caused by the tensioning device instead of by production tolerances and a geometry of the input shaft and the rotor shaft in the region of the interlocking connection.

In one embodiment of the gearbox arrangement, it may be provided that the gearbox arrangement has a radial centering means for positioning the two shafts relative to one another in a radially centered manner. In this way, for example, radial centering of the input shaft relative to the rotor shaft during assembly can be predetermined or at least simplified. Radial centering may be a desired coaxial orientation. The radial centering can prevent inconsistent pressing by the tensioning device. The radial centering may, for example, take place before the tensioning device is adjusted into the tensioning state and, alternatively or additionally, before the shafts are secured together. For example, the radial centering means may be formed by corresponding shoulders on the two shafts. As a result, abutment surfaces running in the circumferential direction and pointing radially outward and inward may be formed, for example. By way of example, the radial centering means may be formed axially in the region of the tensioning device, of the interlocking connection, and, alternatively or additionally, of a means for securing the two shafts together. Here, the two shafts may already have a large wall thickness, and so the radial centering means can be integrated in a simple manner.

In one embodiment of the gearbox arrangement, it may be provided that the gearbox arrangement has a stop for positioning the two shafts relative to one another in an axially defined manner. In this way, for example, an axial position of the input shaft relative to the rotor shaft during assembly can be predetermined or at least simplified. This can thus ensure, for example, that the teeth are fully mated and that the positioning in respective bearings is as desired. The axial positioning may, for example, be carried out before the tensioning device is adjusted into the tensioning state and, alternatively or additionally, before the shafts are fixed together. By way of example, the input shaft is pushed in until it comes up against a stop in the rotor shaft. For example, the stop may be formed by corresponding shoulders on the two shafts. In this way, abutment surfaces running in the circumferential direction and pointing forward may be formed, for example. By way of example, the stop may be formed axially in the region of the tensioning device, of the interlocking connection, and, alternatively or additionally, of a means for securing the two shafts together. Here, the two shafts may already have a large wall thickness, and so the stop can be integrated in a simple manner.

In one embodiment of the gearbox arrangement, it may be provided that the shaft of the gearbox is borne on the further shaft of the wind turbine. For example, the shaft of the gearbox may be borne solely on the further shaft of the wind turbine. In one embodiment, the input shaft may be borne on the rotor shaft of the wind turbine, for example when the wind turbine is in the assembled state. In the assembled wind turbine, the input shaft may be borne solely on the rotor shaft of the wind turbine. For example, the rotor shaft may be borne on the nacelle by means of two rolling bearings or sliding bearings. Owing to the rotor, high loads may act on the rotor shaft, and so a bearing assembly close to the rotor may allow for smaller bearings. By way of example, the rotor shaft is borne on the nacelle by two rolling bearings. The input shaft can then be borne in a simple manner on the rotor shaft. By way of example, the shaft of the gearbox, like the input shaft, is not borne on the gearbox housing, for example neither directly nor indirectly. The rotor shaft may be part of the gearbox arrangement or may be considered to be a separate part therefrom. In the unassembled state, the shaft of the gearbox is not borne in the same way as in the operational state, for example. By way of example, the input shaft is fixed to the gearbox housing during transportation to the assembly site by clamps, cases, pins, screws, or other clamping elements so as to prevent the gearbox from inadvertently shifting position and also being damaged during transportation. During assembly, this fixing can be released and corresponding clamping elements removed.

A second aspect relates to a wind turbine. The wind turbine has a gearbox arrangement according to the first aspect. Embodiments of the first aspect also constitute embodiments of the second aspect, and vice versa. The wind turbine has a rotor. The rotor may, for example, be permanently connected to the rotor shaft of the wind turbine for conjoint rotation. The input shaft of the gearbox, like the planet carrier, may be borne on the rotor shaft of the wind turbine. By way of example, the input shaft may be borne solely on the rotor shaft of the wind turbine. In that case, no other bearings directly support the input shaft, for example. However, the input shaft may, for example, be additionally supported at its toothings and thus at its operative connections to other rotary elements, for example by said particular other rotary elements. The wind turbine may have a generator. The generator may have an input shaft. As described for the first aspect, the input shaft of the generator may be permanently connected to the output shaft of the gearbox for conjoint rotation by an interlocking connection. As described for the first aspect, the input shaft of the gearbox may be permanently connected to the rotor shaft for conjoint rotation by an interlocking connection. The tensioning device may be configured to remove the clearance in both of said connections or just one of the connections. For this purpose, one expansion sleeve may be provided per connection in which the clearance is to be removed, for example.

### DETAILED DESCRIPTION OF EMBODIMENTS

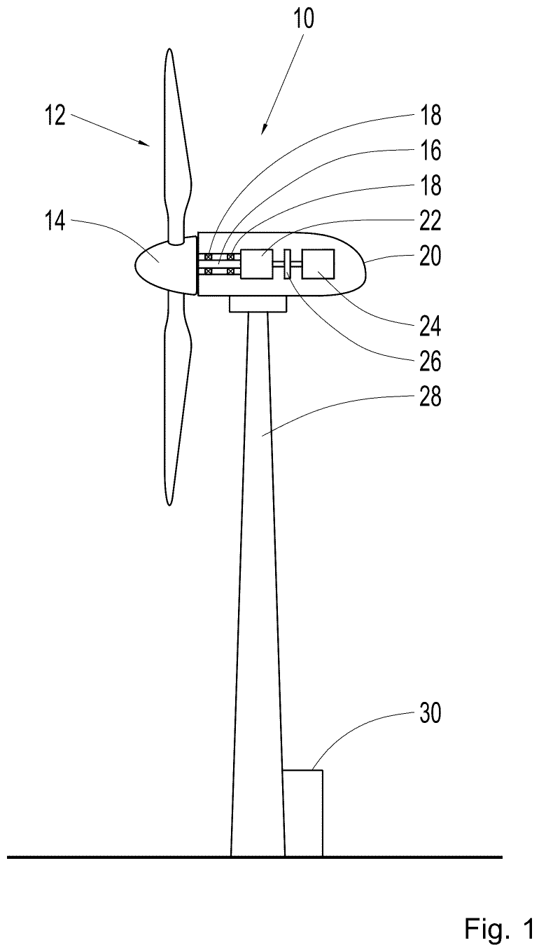

FIG. 1 illustrates a wind turbine 10 in a horizontal design. The wind turbine 10 has a rotor 12, which is held on a rotor shaft 16 by means of a hub 14. The axis of rotation of the rotor shaft 16 extends substantially horizontally. The rotor shaft 16 is borne in a nacelle 20 by means of two rolling bearings 18. The rotor shaft 16 is mechanically operatively connected to a generator 24 by means of a gearbox 22. A brake 26 which acts on an input shaft of the generator 24 is arranged in the operative connection between the gearbox 22 and the generator 24. The nacelle 20 is rotatably borne on a top end of a tower 28 anchored to the ground. Next to the tower 28, the wind turbine 10 has a grid connection 30.

The power of wind turbines is ever increasing. This power has to be able to be transmitted by the gearbox 22. For small nacelles 20, a compact design is desired. In addition, the wind turbine 10 should be able to be maintained. In wind turbines, a limiting factor is often the strength of a connection between two shafts that are permanently interconnected for conjoint rotation. For ease of assembly, a connection having a clearance fit or at least slight pressing is desired. Owing to the high and often changing bending loads and torques induced at the rotor 12, it is desirable during operation for the fit between shafts that are permanently interconnected for conjoint rotation to have a small clearance or even no clearance at all. This can avoid both dynamic loading of the connection and also lubrication, which is otherwise often needed.

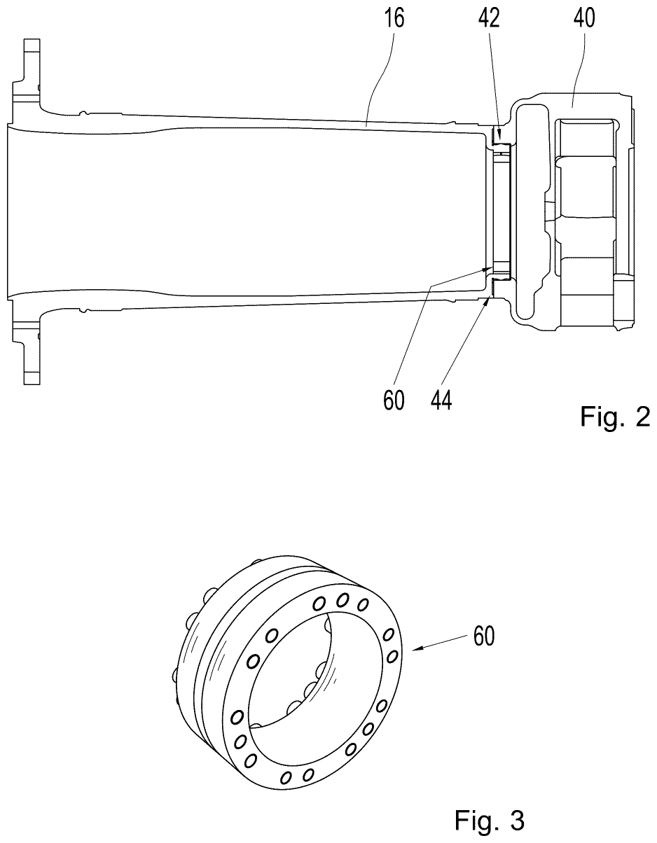

FIG. 2 illustrates a gearbox arrangement of the wind turbine 10 that can simultaneously fulfill these requirements. This is illustrated using the example of a connection of an input shaft 40 of the gearbox 22 to the rotor shaft 16 of the wind turbine 10. The relevant details of the connection are particularly clear to see in FIG. 5. The input shaft 40 is in the form of a planet carrier of a rotor-side planetary gearset of the gearbox 22. However, the gearbox arrangement and the principles of this connection may also be applied to other connections of shafts of the wind turbine 10 that are permanently interconnected for conjoint rotation, like the connection of an output shaft of the gearbox 22 to an input shaft of the generator 24.

It can be seen in FIG. 2 that the rotor shaft 16 is formed as a hollow shaft and is inserted into the input shaft 40 of the gearbox 22 by a gearbox-side end region. In this end region, the rotor shaft 16 has a radially external spline joint. The input shaft 40 of the gearbox 22 is in the form of a planet carrier. The input shaft 40 of the gearbox 22 has a rotor-side end portion which is also formed as a hollow shaft. Here, the input shaft 40 of the gearbox 22 has a radially internal spline joint, which is formed to correspond to the radially external spline joint of the rotor shaft 16. In a connection region 42, therefore, a permanent interlocking co-rotation connection is formed by inserting the rotor shaft 16 into the input shaft 40 of the gearbox 22. To axially secure the two shafts 16, 40 together, axial fixation by a screw is additionally provided in a flange region 44 of the two shafts 16, 40, as illustrated in FIG. 5 by a dashed line 46. The toothings, and thus also the interlocking interconnection of the two shafts 16, 40, are initially configured for assembly as a clearance fit. The input shaft 40 of the gearbox 22 is borne in the assembled wind turbine 10 solely or at least predominantly by means of the rotor shaft 16.

Additionally, in the flange region 44, a shoulder is formed in the rotor shaft 16 and a corresponding shoulder is formed in the input shaft 40 of the gearbox 22. In each case, this shoulder forms a first mating surface 48, running in the circumferential direction and axially, in the two shafts 16, 40. As a result, when the two shafts 16, 40 are connected, with the rotor shaft 16 being inserted into the input shaft 40 of the gearbox 22, radial centering is created for positioning the two shafts 16, 40 relative to one another in a radially centered manner. In this way, the input shaft 16 of the gearbox 22 is oriented coaxially with the rotor shaft 16 to a high degree of precision. Additionally, in each case said shoulder forms a second mating surface 50, running in the circumferential direction and axially, in the two shafts 16, 40. This second mating surface 50 forms a stop for positioning the two shafts 16, 40 relative to one another in an axially defined manner. This can ensure that the spline joints are fully inserted. As a result, the two shafts 16, 40 are positioned particularly precisely in relation to one another in the region of the spline joints. The shoulders are positioned radially far externally in the flange region 44. In other embodiments, the shoulders are arranged radially further internally and, alternatively or additionally, at an axial distance from the connection region 42.

The gearbox arrangement also has a tensioning device 60. The tensioning device 60 is arranged axially in the same region as the flange region 44 and the connection region 42. The tensioning device 60 is arranged radially internally in relation to the rotor shaft 16 and the input shaft 40 of the gearbox 22. The tensioning device 60 directly abuts the rotor shaft 16 radially internally on an all-around radially protruding projection forming the toothing. Thus, the tensioning device 60 is arranged radially at a distance from the input shaft 40 of the gearbox 22 by the rotor shaft 16.

The tensioning device 60 is configured to remove a clearance at least in a sub-region of the interlocking connection. For this purpose, in the example shown, the tensioning device 60 presses from the inside against the all-around radially protruding projection, which forms the toothing, of the rotor shaft 16. As a result, a diameter of the rotor shaft 16 is elastically and also, in one embodiment, plastically deformed slightly in this region. In this way, the teeth of the rotor shaft 16 are pushed radially further into the teeth of the input shaft 40 of the gearbox 22. The tooth flanks thus come into abutment even when the wind turbine 10 is in a state in which no torque is being induced at the rotor 12. The clearance already present therein for assembly purposes is removed at least in this region. In the process, the rotor shaft 16 can be pressed against the input shaft 40 of the gearbox 22 such as to produce a press fit.

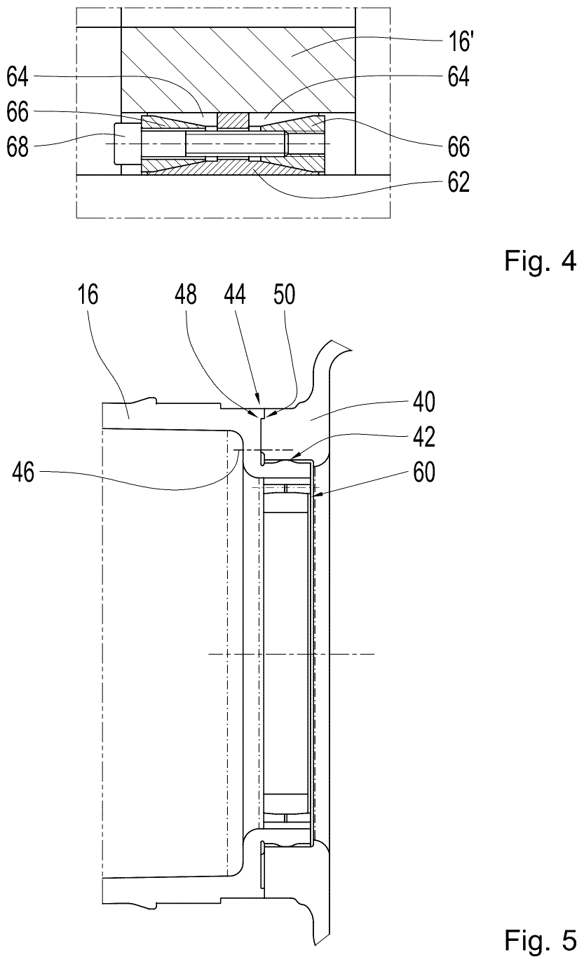

FIGS. 3 and 4 show details of the tensioning device 60, which has an expansion sleeve. The expansion sleeve has a radially inner ring 62 and two radially outer rings 64. In one embodiment as shown in FIG. 3, the two radially outer rings 64 are discontinuous in the circumferential direction. These rings 62, 64 converge in a wedge-like manner in an axial central region of the expansion sleeve. Two rings 66 having a wedge-shaped cross section with a corresponding slope are arranged between said three rings 62, 64. These two wedge-shaped rings 66 are connected by means of tensioning elements 68 which are evenly distributed over the circumference and which are formed as screws here. In an initial position, the two wedge-shaped rings 66 have a minimum spacing, which corresponds to the maximum initial thickness, and thus a maximum initial external diameter, of the expansion sleeve. Tightening the tensioning elements 68, i.e., turning the screws in this case, moves these two central wedge-shaped rings 66 toward one another. As a result, the radially outer rings 64 and the radially inner ring 62 are pushed radially apart. In this way, the thickness, and thus an external diameter of the expansion sleeve, is increased by comparison with the initial state, and the tensioning device 60 is moved into a tensioning state in which it presses against the rotor shaft 16 from the inside in the connection region 42. The tension can thus be mechanically adjusted continuously and corresponds to a force needed to turn the screws. In a further embodiment, the expansion sleeve is configured to be hydraulically adjusted.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

10 Wind turbine
12 Rotor
14 Hub
16 Rotor shaft
18 Rolling bearing
20 Nacelle
22 Gearbox
24 Generator
26 Brake
28 Tower
30 Grid connection
40 Input shaft
42 Connection region
44 Flange region
46 Line/screw
48, 50 Mating surfaces
60 Tensioning device
62, 64, 66 Rings
68 Tensioning elements

1. A gearbox arrangement for a wind turbine, comprising:
a gearbox,
wherein a shaft of the gearbox is permanently connected to a further shaft of the wind turbine for conjoint rotation by an interlocking connection when the wind turbine is in an assembled state, and
wherein the gearbox arrangement has a tensioning device configured to remove a clearance at least in a sub-region of the interlocking connection.

2. The gearbox arrangement according to claim 1, wherein the interlocking connection is formed by corresponding toothings of the shaft and the further shaft.

3. The gearbox arrangement according to claim 2, wherein the tensioning device is configured to remove the clearance at least in a region of tooth flanks, which are adjacent to one another in a circumferential direction, of the corresponding toothings.

4. The gearbox arrangement according to claim 1wherein the tensioning device is configured to press against that shaft out of the shaft and the further shaft which is arranged radially adjacent to the tensioning device.

5. The gearbox arrangement according to claim 1wherein the tensioning device has an expansion sleeve configured to expand.

6. The gearbox arrangement according to claim 1wherein an expansion sleeve is arranged radially internally in relation to the shaft and the further shaft.

7. The gearbox arrangement according to claim 1, wherein the interlocking connection is formed as a clearance fit at least in the sub-region.

8. The gearbox arrangement according to claim 1wherein the gearbox arrangement has a radial centering means for positioning the shaft and the further shaft relative to one another in a radially centered manner.

9. The gearbox arrangement according to claim 1wherein the gearbox arrangement has a stop for positioning the shaft and the further shaft relative to one another in an axially defined manner.

10. The gearbox arrangement according to claim 1, wherein the shaft of the gearbox is borne on the further shaft of the wind turbine.

11. A wind turbine comprising the gearbox arrangement according to claim 1 and a rotor.
